(19) United States
(12) Patent Application Publication
(10) Pub. No.: US 2026/0246556 A1
(43) Pub. Date: Aug. 20, 2026

(54) OPTICAL COMMUNICATION NETWORK SYSTEM

(71) Applicants: NEC Corporation, Tokyo (JP); KEIO UNIVERSITY, Tokyo (JP)

(72) Inventors: Shigeyuki YANAGIMACHI, Tokyo (JP); Wakako YASUDA, Tokyo (JP); Naoaki YAMANAKA, Kanagawa (JP); Satoru OKAMOTO, Kanagawa (JP); Takashi MIYAMURA, Kanagawa (JP)

(73) Assignees: NEC Corporation, Tokyo (JP); KEIO UNIVERSITY, Tokyo (JP)

(21) Appl. No.: 19/539,290

(22) Filed: Feb. 13, 2026

(30) Foreign Application Priority Data
Feb. 20, 2025 (JP) 2025-025531

(51) Int. Cl. H04J 14/02

(52) U.S. Cl. CPC H04J 14/0204; H04J 14/0227; H04J 14/0246; H04J 14/028; H04J 14/0283

(57) ABSTRACT

An optical communication network system includes a wavelength selective switch (WSS) capable of selecting an output port for each wavelength component of a signal input from an input port, a first multiplexing network and a second multiplexing network each including an optical transmission configuration in which a plurality of couplers is connected in a tree shape and each connected to the input port of the WSS, and a first demultiplexing network and a second demultiplexing network each including an optical transmission configuration in which a plurality of couplers is connected in a tree shape and each connected to the output port of the WSS.

### INCORPORATION BY REFERENCE

This application is based upon and claims the benefit of priority from Japanese patent application No. 2025-025531, filed on Feb. 20, 2025, the disclosure of which is incorporated herein in its entirety by reference.

### TECHNICAL FIELD

The present disclosure relates to an optical communication network system.

### BACKGROUND ART

An architecture using a filtered optical network (FON) has been proposed as an architecture of a reconfigurable optical add-drop multiplexer (ROADM) (for example, NPL 1: Omran Ayoub, Oleg Karandin, Memedhe Ibrahimi, Andrea Castoldi, Francesco Musumeci, and Massimo Tornatore, “Tutorial on filterless optical networks [Invited]”, J. Opt. Commun. Netw. 14, 1-15 (2022).). Ayoub et al. propose a FON in which two optical transmission configurations in which a plurality of couplers is connected in a tree shape are connected by top couplers. Since the FON is mainly configured by a passive optical device such as an optical coupler and a splitter, a low power consumption and low cost network can be achieved.

### SUMMARY

However, since an optical signal is broadcast in a downstream direction in a passive optical device, reuse of a wavelength is limited in the ROADM architecture proposed in Ayoub et al., and accommodation efficiency of an optical path is reduced.

An object of the present disclosure is to provide an optical communication network system capable of improving wavelength utilization efficiency. The object is merely one of a plurality of objects to be achieved by a plurality of example embodiments disclosed in the present specification. The other objects or problems and novel features will be apparent from the description of the present specification or the accompanying drawings.

An optical communication network system according to the present disclosure includes a wavelength selective switch (WSS) that includes a first input port, a second input port, a first output port, and a second output port, and is capable of selecting an output port for each wavelength component of a signal input from the input port, a first multiplexing network comprising S₁ (S₁ is an integer of 2 or more) input ports and at least one output port, the first multiplexing network including an optical transmission configuration in which a plurality of couplers are connected in a tree shape, the first multiplexing network being connected to the first input port of the WSS, a second multiplexing network comprising S₂ (S₂ is an integer of 2 or more) input ports and at least one output port, the second multiplexing network including an optical transmission configuration in which a plurality of couplers are connected in a tree shape, the second multiplexing network being connected to the second input port of the WSS, a first demultiplexing network comprising at least one input port and T₁ (T₁ is an integer of 2 or more) output ports, the first demultiplexing network including an optical transmission configuration in which a plurality of couplers are connected in a tree shape, the first demultiplexing network being connected to the first output port of the WSS, and a second demultiplexing network comprising at least one input port and T₂ (T₂ is an integer of 2 or more) output ports, the second demultiplexing network including an optical transmission configuration in which a plurality of couplers are connected in a tree shape, the second demultiplexing network being connected to the second output port of the WSS.

According to the present disclosure, it is possible to provide an optical communication network system capable of improving utilization efficiency of a wavelength.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating one example of an optical communication network system according to the present disclosure;

FIG. 2A is a diagram for explaining communication using the optical communication network system according to the present disclosure;

FIG. 2B is a diagram for explaining the communication using the optical communication network system according to the present disclosure;

FIG. 3 is a block diagram illustrating another example of the optical communication network system according to the present disclosure;

FIG. 4 is a diagram illustrating an example of wavelength allocation according to the present disclosure;

FIG. 5 is a block diagram illustrating still another example of the optical communication network system according to the present disclosure;

FIG. 6 is a block diagram illustrating an example of an optical communication network system in a case where a 4×4 wavelength selective switch is adopted; and

FIG. 7 is a block diagram illustrating further another example of the optical communication network system according to the present disclosure.

### EXAMPLE EMBODIMENTS

Hereinafter, example embodiments will be described with reference to the drawings. In the present disclosure, the drawings can be associated with one or more example embodiments. Each element of the drawings can be applied to one or more example embodiments. In the example embodiments, the same or equivalent elements are denoted by the same reference signs, and repeated description will be omitted. In the present disclosure, a “device” may include one or a plurality of devices. In the present disclosure, a “system” may include one or a plurality of devices. That is, in the present disclosure, the “device” may be read as the “system”, and the “system” may be read as the “device”.

### First Example Embodiment

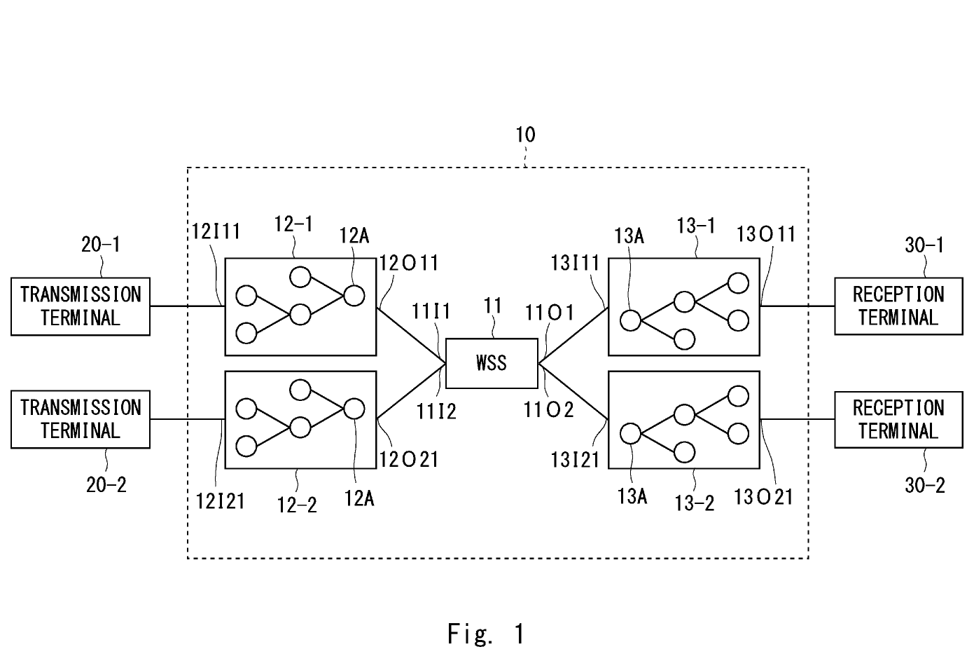

FIG. 1 is a block diagram illustrating an example of an optical communication network system according to the present disclosure. In FIG. 1, an optical communication network system 10 includes a wavelength selective switch (WSS) 11, multiplexing networks 12-1 and 12-2, and demultiplexing networks 13-1 and 13-2. Hereinafter, in a case where the multiplexing networks 12-1 and 12-2 are not distinguished, each of the multiplexing networks 12-1 and 12-2 or the multiplexing networks 12-1 and 12-2 may be collectively referred to simply as a multiplexing network 12. In a case where the demultiplexing networks 13-1 and 13-2 are not distinguished, each of the demultiplexing networks 13-1 and 13-2 or the demultiplexing networks 13-1 and 13-2 may be collectively referred to simply as a demultiplexing network 13.

In this example, the description will be made on the assumption that the number of input ports of the wavelength selective switch 11 is 2 and the number of output ports is 2, but the number of input ports and the number of output ports of the wavelength selective switch 11 are not limited thereto. The number of input ports of the wavelength selective switch 11 may be 3 or more and the number of output ports may be 3 or more. That is, the number of multiplexing networks 12 is not limited to two and may be three or more. The number of demultiplexing networks 13 is not limited to two and may be three or more.

The multiplexing network 12 includes an optical transmission configuration in which a plurality of couplers 12A is connected in a tree shape. The multiplexing network 12-1 includes S₁ (S₁ is an integer of 2 or more) input ports 12I1 and an output port 12O11 connected to an input port 11I1 of the WSS 11. Each coupler 12A has two inputs and one output. The two couplers 12A are connected by an optical transmission line. The input port 12I1 and the coupler 12A are also connected by an optical transmission line. The coupler 12A and the output port 12O11 are also connected by an optical transmission line. In FIG. 1, an input port 12I11 represents one input port among the S₁ input ports 12I1 of the multiplexing network 12-1. In FIG. 1, the output port 12O11 represents one of output ports 12O1 of the multiplexing network 12-1.

The multiplexing network 12-2 includes S₂ (S₂ is an integer of 2 or more) input ports 12I2 and an output port 12O21 connected to an input port 11I2 of the WSS 11. In FIG. 1, an input port 12I21 represents one of S₂ input ports 12I2 of the multiplexing network 12-2. In FIG. 1, the output port 12O21 represents one of the output ports 12O1 of the multiplexing network 12-2.

The demultiplexing network 13 includes an optical transmission configuration in which a plurality of couplers 13A is connected in a tree shape. The demultiplexing network 13-1 includes an input port 13I11 connected to an output port 11O1 of the WSS 11 and T₁ (T₁ is an integer of 2 or more) output ports 13O1. The two couplers 13A are connected by an optical transmission line. An input port 13I1 and the coupler 13A are also connected by an optical transmission line. The coupler 13A and the output port 13O1 are also connected by an optical transmission line. In FIG. 1, an output port 13O11 represents one output port among T₁ output ports 13O1 of the demultiplexing network 13-1. In FIG. 1, the input port 13I11 represents one of the input ports 13I1 of the demultiplexing network 13-1.

The demultiplexing network 13-2 includes an input port 13I21 connected to an output port 11O2 of the WSS 11 and T₂ (T₂ is an integer of 2 or more) output ports 13O2. In FIG. 1, an output port 13O21 represents one of the T₂ output ports 13O2 of the demultiplexing network 13-2. In FIG. 1, the input port 13I21 represents one of input ports 13I2 of the demultiplexing network 13-2.

Here, the output port 12O11 of the multiplexing network 12-1 may be connected to a top coupler 12A located at a top of the tree-like optical transmission configuration of the multiplexing network 12-1. Similarly, the output port 12O21 of the multiplexing network 12-2 may be connected to a top coupler 12A located at a top of the above-described tree-like optical transmission configuration of the multiplexing network 12-2. Similarly, the input port 13I11 of the demultiplexing network 13-1 may be connected to a top coupler 13A located at a top of the above-described tree-like optical transmission configuration of the demultiplexing network 13-1. Similarly, the input port 13I21 of the demultiplexing network 13-2 may be connected to a top coupler 13A located at a top of the above-described tree-like optical transmission configuration of the demultiplexing network 13-2.

Alternatively, as in an example embodiment described below, the output port 12O11 of the multiplexing network 12-1 may be connected to an intermediate coupler 12A (for example, a second-layer coupler) located in the middle of the above-described tree-like optical transmission configuration of the multiplexing network 12-1. Similarly, the output port 12O21 of the multiplexing network 12-2 may be connected to an intermediate coupler 12A (for example, a second-layer coupler) located in the middle of the above-described tree-like optical transmission configuration of the multiplexing network 12-2. Similarly, the input port 13I11 of the demultiplexing network 13-1 may be connected to an intermediate coupler 13A (for example, the coupler of a second layer) located in the middle of the above-described tree-like optical transmission configuration of the demultiplexing network 13-1. Similarly, the input port 13I21 of the demultiplexing network 13-2 may be connected to an intermediate coupler 13A (for example, the coupler of a second layer) located in the middle of the above-described tree-like optical transmission configuration of the demultiplexing network 13-2.

The wavelength selective switch 11 has a demultiplexing function, a switching function, and a multiplexing function. The wavelength selective switch 11 includes the input ports 11I1 and 11I2 and the output ports 11O1 and 11O2.

For example, consider a case where different transmission wavelengths are allocated to a plurality of transmission terminals 20 connected to a plurality of input ports 12I of the multiplexing network 12-1. In this case, a multiplexed signal obtained by multiplexing signals having different wavelengths transmitted from the plurality of transmission terminals 20 is input to the input port 11I1 of the wavelength selective switch 11. The wavelength selective switch 11 separates the multiplexed signal input to the input port 11I1 into components for each wavelength by the demultiplexing function. Then, the wavelength selective switch 11 can select an output destination of any wavelength component obtained by the demultiplexing function from the output ports 11O1 and 11O2 by the switching function. Then, the wavelength selective switch 11 can multiplex wavelength components for each output port 11O and output a multiplexed signal by a multiplexing function. For example, the multiplexed signal output from the output port 11O1 is input to the demultiplexing network 13-1 and broadcast toward the T ₁ (T₁ is an integer of 2 or more) output ports 13O1 of the demultiplexing network 13-1. A reception terminal 30 connected to the output port 13O1 extracts a component associated with a wavelength allocated to itself from the received multiplexed signal.

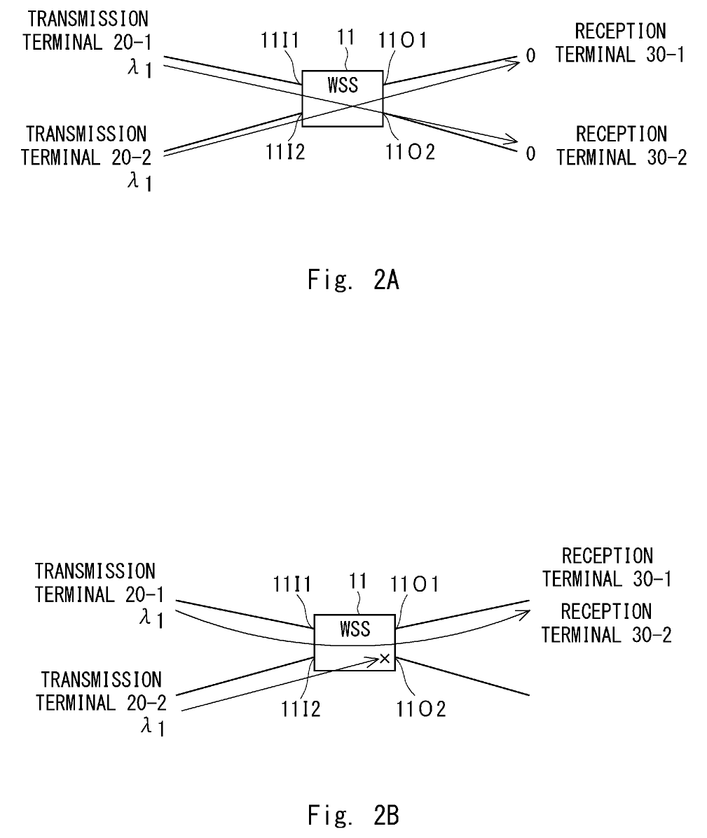

FIGS. 2A and 2B are diagrams for explaining communication using the optical communication network system according to the present disclosure.

First, as illustrated in FIG. 1, it is assumed that a transmission terminal 20-1 connected to the input port 12I11 of the multiplexing network 12-1 and a reception terminal 30-2 connected to the output port 13O21 of the demultiplexing network 13-2 are a first communication pair that communicate with each other. It is assumed that a transmission terminal 20-2 connected to the input port 12I21 of the multiplexing network 12-2 and a reception terminal 30-1 connected to the output port 13O11 of the demultiplexing network 13-1 are a second communication pair that communicate with each other. In this case, the multiplexing network 12-1 and the demultiplexing network 13-2 associated with the first communication pair are completely different from the multiplexing network 12-2 and the demultiplexing network 13-1 associated with the second communication pair. Therefore, as illustrated in FIG. 2A, a common wavelength λ1 can be allocated to both the first communication pair and the second communication pair. As a result, since one wavelength can be reused between the communication pairs, wavelength utilization efficiency can be improved.

For example, in a case where the reception terminal 30-2 is also connected to the output port 13O1 of the demultiplexing network 13-1 similarly to the reception terminal 30-1, as illustrated in FIG. 2B, the common wavelength λ1 cannot be allocated to both the first communication pair and the second communication pair, and it is necessary to allocate different wavelengths to the first communication pair and the second communication pair. As a matter of course, a common wavelength cannot be allocated to a plurality of transmission terminals 20 connected to the same multiplexing network 12. Similarly, a common wavelength cannot be allocated to a plurality of reception terminals 30 connected to the same demultiplexing network 13.

The transmission terminal 20 is configured to be communicable using a wavelength selected from a plurality of wavelengths. For example, the transmission terminal 20 may include a fixed wavelength laser light source and a variable wavelength filter. Alternatively, the transmission terminal 20 may include a variable wavelength laser light source.

As described above, according to the first example embodiment, in the optical communication network system 10, the wavelength selective switch 11 includes the input ports 11I1 and 11I2 and the output ports 11O1 and 11O2. The wavelength selective switch 11 is configured to be able to select an output port for each wavelength component of the signal input from the input port. The multiplexing network 12 includes an optical transmission configuration in which a plurality of couplers 12A is connected in a tree shape. The multiplexing network 12-1 includes S₁ (S₁ is an integer of 2 or more) input ports 12I1 and an output port 12O11 connected to an input port 11I1 of the WSS 11. The multiplexing network 12-2 includes the S₂ (S₂ is an integer of 2 or more) input ports 12I2 and the output port 12O21 connected to the input port 11I2 of the WSS 11. The demultiplexing network 13 includes an optical transmission configuration in which a plurality of couplers 13A is connected in a tree shape. The demultiplexing network 13-1 includes an input port 13I11 connected to an output port 11O1 of the WSS 11 and T₁ (T₁ is an integer of 2 or more) output ports 13O1. The demultiplexing network 13-2 includes the input port 13I21 connected to the output port 11O2 of the WSS 11 and the T₂ (T₂ is an integer of 2 or more) output ports 13OB. That is, the optical communication network system 10 is configured to be able to set a number of optical paths equal to a value obtained by multiplying a value obtained by adding S ₁ and S₂ and a value obtained by adding T₁ and T₂.

With the configuration of the optical communication network system 10, wavelength utilization efficiency can be improved. With the configuration of the optical communication network system 10, it is possible to avoid providing a wavelength converter in the WSS 11 and to avoid providing a large-scale spatial switch in the WSS 11. As a result, it is possible to realize low power consumption and low cost.

As described above, the number of input ports and the number of output ports of the wavelength selective switch 11, the number of multiplexing networks 12, and the number of demultiplexing networks 13 are not limited to two. The optical communication network system 10 can be rephrased as follows. An optical communication network system 10 includes: an n×n wavelength selective switch (WSS) that has n (n is an integer of 2 or more) input ports and n output ports and is capable of selecting an output port for each wavelength component of a signal input from the input ports; n multiplexing networks connected to the n input ports of the WSS where an i-th (i is an integer of 1 or more and n or less) multiplexing network has Sᵢ input ports and an output port connected to any of the input ports of the WSS; and n demultiplexing networks connected to the n output ports of the WSS, where a j-th (j is an integer of 1 or more and n or less) demultiplexing network has an input port connected to any of the output ports of the WSS, and Tⱼ (j is an integer of 1 or more and n or less) output ports. That is, the optical communication network system 10 is configured to be able to set a number of optical paths equal to a value obtained by multiplying a value obtained by adding Sᵢ for the n multiplexing networks and a value obtained by adding Tⱼ for the n demultiplexing networks. For example, even in a case where n is 3 or more, a basic configuration of the optical communication network system 10 illustrated in FIG. 1 is also included in the optical communication network system 10 in a case where n is 3 or more.

### Second Example Embodiment

A second example embodiment relates to wavelength allocation.

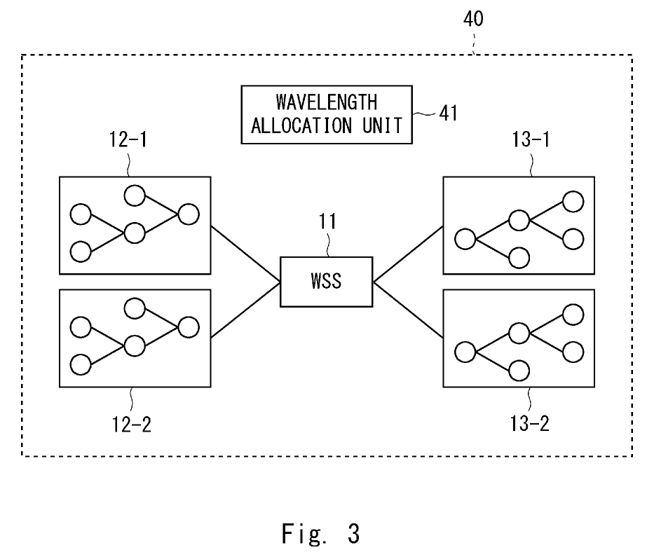

FIG. 3 is a block diagram illustrating another example of the optical communication network system according to the present disclosure. In FIG. 3, an optical communication network system 40 includes a wavelength allocation unit 41, a wavelength selective switch 11, multiplexing networks 12-1 and 12-2, and demultiplexing networks 13-1 and 13-2.

In a case where a communication partner terminal of the transmission terminal 20-1 connected to the multiplexing network 12-1 illustrated in FIG. 1 and a communication partner terminal of the transmission terminal 20-2 connected to the multiplexing network 12-2 are connected to the same demultiplexing network 13, a wavelength allocation unit 41 allocates different wavelengths to the transmission terminal 20-1 and the transmission terminal 20-2. In a case where the communication partner terminal of the transmission terminal 20-1 and the communication partner terminal of the transmission terminal 20-2 are connected to different demultiplexing networks 13, the wavelength allocation unit 41 allocates the same or different wavelengths to the transmission terminal 20-1 and the transmission terminal 20-2.

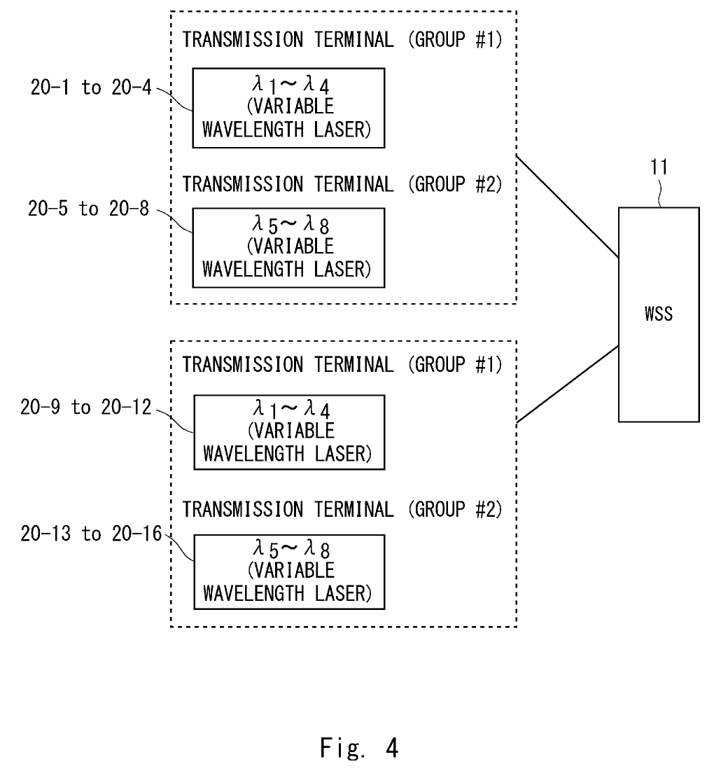

FIG. 4 is a diagram illustrating an example of wavelength allocation according to the present disclosure. FIG. 4 illustrates, for example, a situation in which transmission terminals 20-1 to 20-4 and transmission terminals 20-9 to 20-12 have transmittable wavelengths λ1 to λ4 in common and belong to a group # 1. Transmission terminals 20-5 to 20-8 and transmission terminals 20-13 to 20-16 have transmittable wavelengths λ5 to λ8 in common and belong to a group # 2. The transmission terminals 20-1 to 20-4 and the transmission terminals 20-5 to 20-8 are connected to the multiplexing network 12-1. The transmission terminals 20-9 to 20-12 and the transmission terminals 20-13 to 20-16 are connected to the multiplexing network 12-2.

Even in two transmission terminals 20 belonging to the same group, if the multiplexing network 12 to which the two transmission terminals 20 are connected is different and the two communication partner terminals of the two transmission terminals 20 are connected to different demultiplexing networks 13, the wavelength allocation unit 41 can allocate the same wavelength to the two transmission terminals 20. On the other hand, in a case where the multiplexing networks 12 to which the two transmission terminals 20 belonging to the same group are connected are different from each other, and the two communication partner terminals of the two transmission terminals 20 are connected to the same demultiplexing network 13, the wavelength allocation unit 41 needs to allocate different wavelengths to the two transmission terminals 20.

### Third Example Embodiment

A third example embodiment relates to a configuration for increasing the number of wavelengths available in an optical communication network system.

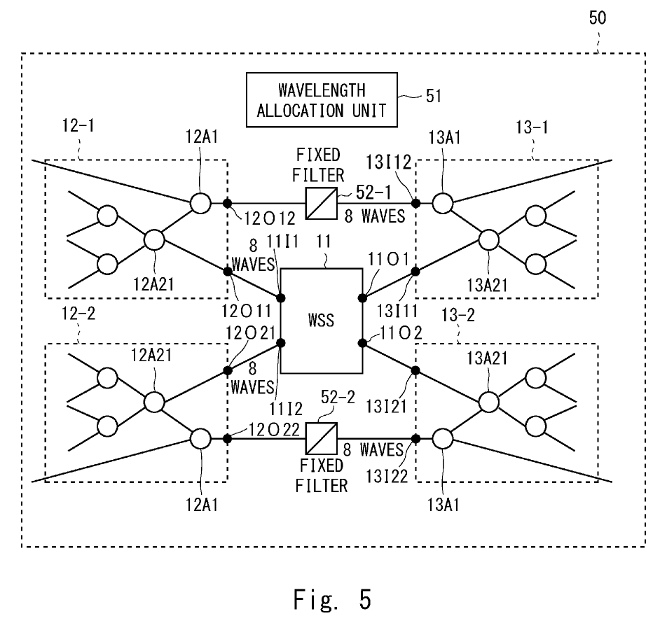

FIG. 5 is a block diagram illustrating still another example of the optical communication network system according to the present disclosure. In FIG. 5, an optical communication network system 50 includes a wavelength allocation unit 51, wavelength filters 52-1 and 52-2, a wavelength selective switch 11, multiplexing networks 12-1 and 12-2, and demultiplexing networks 13-1 and 13-2.

In FIG. 5, the multiplexing network 12-1 includes an output port 12O11 and an output port 12O12. The output port 12O11 is connected to an intermediate coupler 12A21 between a top coupler 12A1 and a bottom coupler 12A in an optical transmission configuration of the multiplexing network 12-1. The intermediate coupler 12A21 has two inputs and two outputs. The coupler 12AB means a first layer (that is, top) coupler 12A. This means that the intermediate coupler 12A21 is one coupler 12A of the couplers 12A of a second layer. The output port 12O11 is connected to an input port 11I1 of the wavelength selective switch 11. The output port 12O12 is connected to the top coupler 12A1. The output port 12O12 is connected to an input port 13I12 of the demultiplexing network 13-1 via the wavelength filter 52-1.

The multiplexing network 12-2 includes an output port 12O21 and an output port 12O22. The output port 12O21 is connected to an intermediate coupler 12A21 between a top coupler 12A1 and bottom couplers 12A in the optical transmission configuration of the multiplexing network 12-2. The output port 12O21 is connected to an input port 11I2 of the wavelength selective switch 11. The output port 12O22 is connected to the top coupler 12A1. The output port 12O22 is connected to an input port 13I22 of the demultiplexing network 13-2 via the wavelength filter 52-2.

The demultiplexing network 13-1 includes an input port 13I11 and the input port 13I12. The input port 13I11 is connected to an intermediate coupler 13A21 between a top coupler 13A1 and bottom couplers 13A in the optical transmission configuration of the demultiplexing network 13-1. The intermediate coupler 13A21 has two inputs and two outputs. The coupler 13A1 means a first layer (that is, top) coupler 13A. This means that the intermediate coupler 13A21 is one coupler 13A of the couplers 13A of the second layer. The input port 13I11 is connected to an output port 11O1 of the wavelength selective switch 11. The input port 13I12 is connected to the top coupler 13A1. The input port 13I12 is connected to the output port 12O12 of the multiplexing network 12-1 via the wavelength filter 52-1.

The demultiplexing network 13-2 includes an input port 13I21 and the input port 13I22. The input port 13I21 is connected to an intermediate coupler 13A21 between a top coupler 13A1 and bottom couplers 13A in the optical transmission configuration of the demultiplexing network 13-2. The input port 13I21 is connected to an output port 11O2 of the wavelength selective switch 11. The input port 13I22 is connected to the top coupler 13A1. The input port 13I22 is connected to the output port 12O22 of the multiplexing network 12-2 via the wavelength filter 52-2.

In the third example embodiment, the wavelength selective switch 11 is configured to be able to receive multiplexed signals of 8 wavelengths at each of the input ports 11I1 and 11I2. The wavelength selective switch 11 is configured to be able to transmit multiplexed signals of 8 wavelengths at each of the output ports 11O1 and 11O2. In this case, the wavelength allocation unit 51 allocates a wavelength from a “first wavelength group” to the transmission terminal 20 connected to the input port 12I1 located below the intermediate coupler 12A21 of the multiplexing network 12-1. The wavelength allocation unit 51 allocates a wavelength from a “second wavelength group” to the transmission terminal 20 connected to the input port 12I1 other than the input port 12I1 located below the intermediate coupler 12A21 among the input ports 12I1 of the multiplexing network 12-1. The wavelength allocation unit 51 allocates a wavelength from the “first wavelength group” to the transmission terminal 20 connected to the input port 12I2 located below the intermediate coupler 12A21 of the multiplexing network 12-2. The wavelength allocation unit 51 allocates a wavelength from a “third wavelength group” to the transmission terminal 20 connected to the input port 12I2 other than the input port 12I2 located below the intermediate coupler 12A21 among the input ports 12I2 of the multiplexing network 12-2. The second wavelength group and the third wavelength group may have the same constituent wavelength. The wavelengths included in the first wavelength group and the second wavelength group (third wavelength group) do not overlap each other. Here, it is assumed that each of the first wavelength group, the second wavelength group, and the third wavelength group includes eight wavelengths.

The wavelength filter 52-1 is, for example, a fixed filter. The wavelength filter 52-1 passes wavelengths of the second wavelength group and blocks the other wavelengths. The wavelength filter 52-2 is, for example, a fixed filter. The wavelength filter 52-2 passes the wavelengths of the third wavelength group and blocks the other wavelengths.

In the optical communication network system 50, the reception terminal 30 connected to the output port 13O1 of the demultiplexing network 13-1 receives a multiplexed signal of up to 16 wavelengths. Similarly, the reception terminal 30 connected to the output port 13O2 of the demultiplexing network 13-2 receives a multiplexed signal of up to 16 wavelengths. As described above, even if the demultiplexing network 13-1 has an ability to handle multiplexed signals of 8 wavelengths, the entire optical communication network system 50 can handle multiplexed signals of 16 wavelengths.

The transmission terminal 20 to which the second wavelength group is allocated can be a terminal group fixed to the reception terminal 30 whose communication partner is connected to the demultiplexing network 13-1. Similarly, the transmission terminal 20 to which the third wavelength group is allocated can be a terminal group fixed to the reception terminal 30 whose communication partner is connected to the demultiplexing network 13-2. The transmission terminal 20 to which the first wavelength group is allocated can be a terminal group from which both the reception terminal 30 connected to the demultiplexing network 13-1 and the reception terminal 30 connected to the demultiplexing network 13-2 can be selected as communication partners.

### Fourth Example Mmbodiment

A fourth example embodiment relates to an example embodiment capable of reducing a scale of a wavelength selective switch adopted in an optical communication network system of the present disclosure.

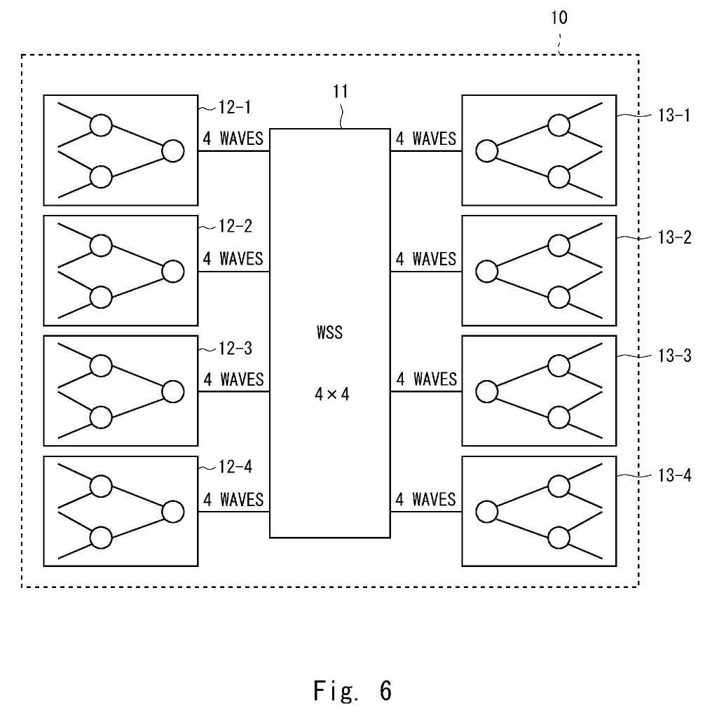

FIG. 6 is a block diagram illustrating an example of an optical communication network system in a case where a 4×4 wavelength selective switch is adopted.

In FIG. 6, an optical communication network system 10 includes a wavelength selective switch 11, multiplexing networks 12-1,12-2,12-3, and 12-4, and demultiplexing networks 13-1,13-2,13-3, and 13-4.

In FIG. 6, the wavelength selective switch 11 is configured to be able to receive a multiplexed signal of four wavelengths at each input port. The wavelength selective switch 11 is configured to be able to transmit a multiplexed signal of four wavelengths at each output port.

It is known that the wavelength selective switch is costly with the square of the number of ports. Therefore, a configuration in which the number of ports of the wavelength selective switch is small is advantageous.

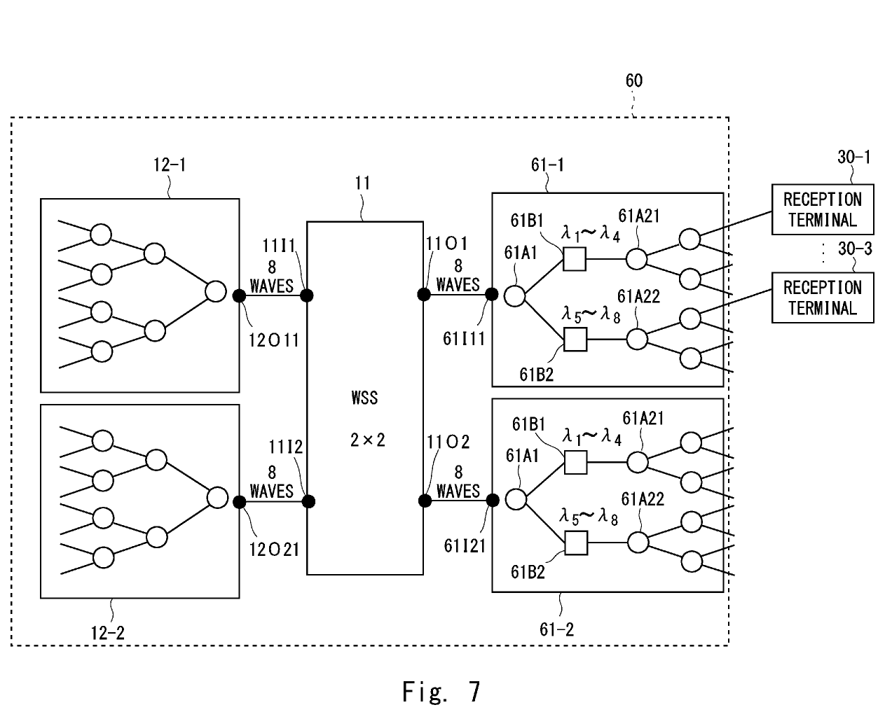

FIG. 7 is a block diagram illustrating further another example of the optical communication network system according to the present disclosure. In FIG. 7, an optical communication network system 60 includes a wavelength selective switch 11, multiplexing networks 12-1 and 12-2, and demultiplexing networks 61-1 and 61-2.

In FIG. 7, the wavelength selective switch 11 is a 2×2 WSS. In FIG. 7, the wavelength selective switch 11 is configured to be able to receive multiplexed signals of 8 wavelengths at each of input ports 11I1 and 11I2. The wavelength selective switch 11 is configured to be able to transmit multiplexed signals of 8 wavelengths at each of output ports 11O1 and 11O2.

The demultiplexing network 61 includes an optical transmission configuration in which a plurality of couplers 61A is connected in a tree shape. The demultiplexing network 61-1 includes an input port 61I11 connected to the output port 11O1 of the WSS 11 and a plurality of output ports 61O. The demultiplexing network 61-1 has a wavelength filter 61B1 between a top coupler 61A1 and a second-layer coupler 61A21 in the optical transmission configuration of the demultiplexing network 61-1. The wavelength filter 61B1 is, for example, a fixed wavelength filter, a variable wavelength filter, or a band pass filter. The demultiplexing network 61-1 has a wavelength filter 61B2 between the top coupler 61A1 and a second-layer coupler 61A22 in the optical transmission configuration of the demultiplexing network 61-1. The wavelength filter 61B2 is, for example, a fixed wavelength filter, a variable wavelength filter, or a band pass filter. The wavelength passed by the wavelength filter 61B1 is different from the wavelength passed by the wavelength filter 61B2. For example, as illustrated in FIG. 7, the wavelength filter 61B1 passes wavelengths λ1, λ2, λ3, and λ4 and blocks other wavelengths, while the wavelength filter 61BB passes wavelengths λ5, λ6, λ7, and λ8 and blocks other wavelengths.

As described above, the demultiplexing network 61-1 has the wavelength filter 61B1 between the top coupler 61A1 and the second-layer coupler 61A21 in the optical transmission configuration of the demultiplexing network 61-1 and has the wavelength filter 61B2 between the top coupler 61A1 and the second-layer coupler 61A22. The wavelength groups passed by the wavelength filter 61B1 and the wavelength groups passed by the wavelength filter 61B2 do not overlap with each other in terms of wavelengths included in the groups. With the configuration of the demultiplexing network 61-1, a subnetwork of an output stage of the wavelength filter 61B1 and a subnetwork of an output stage of the wavelength filter 61B2 can be constructed. In FIG. 7, the reception terminal 30-1 connected to the subnetwork of the output stage of the wavelength filter 61B1 may extract a wavelength allocated to the reception terminal 30-1 among the wavelengths λ1, λ2, λ3, and λ4. In FIG. 7, a reception terminal 30-3 connected to the subnetwork of the output stage of the wavelength filter 61B2 may extract a wavelength allocated to the reception terminal 30-3 among the wavelengths λ5, λ6, λ7, and λ8.

The demultiplexing network 61-2 includes an input port 61I21 connected to the output port 11O2 of the WSS 11 and a plurality of output ports 61O. The demultiplexing network 61-2 has a wavelength filter 61B1 between the top coupler 61A1 and the second-layer coupler 61A21 in the optical transmission configuration of the demultiplexing network 61-2. The demultiplexing network 61-2 has a wavelength filter 61B2 between the top coupler 61A1 and the second-layer coupler 61A22 in the optical transmission configuration of the demultiplexing network 61-2.

### Other Example Embodiments

Each of the optical communication network systems 40 and 50 according to the second example embodiment and the third example embodiment may include a processor and a memory. The processor may be, for example, a microprocessor, a micro processing unit (MPU), or a central processing unit (CPU). The processor may include a plurality of processors. The memory includes a combination of a volatile memory and a nonvolatile memory. The memory may include a storage disposed away from the processor. In this case, the processor may access the memory through an I (input)/O (output) interface (not shown).

The wavelength allocation units 41 and 51 of the optical communication network systems 40 and 50 may be implemented by a processor reading and executing a program stored in a memory. That is, the wavelength allocation units 41 and 51 of the optical communication network systems 40 and 50 can be implemented by software. The programs may be stored using various types of non-transitory computer readable media and supplied to the communication network systems 40 and 50. Examples of the non-transitory computer readable medium include magnetic recording medium (e.g., flexible disks, magnetic tapes, or hard disk drives), and magneto-optical recording medium (e.g., magneto-optical disks). Other examples of the non-transitory computer readable medium include a read only memory (CD-ROM), a CD-R, and a CD-R/W. Other examples of the non-transitory computer readable medium include a semiconductor memory. Examples of the semiconductor memory include a mask ROM, a programmable ROM (PROM), an erasable PROM (EPROM), a flash ROM, and a random access memory (RAM). The program may be supplied to the communication network systems 40 and 50 by various types of transitory computer readable media. Examples of the transitory computer readable media include electrical signals, optical signals, and electromagnetic waves. The transitory computer readable medium can supply a program to the communication network systems 40 and 50 via a wired communication path such as an electric wire and an optical fiber or a wireless communication path.

Alternatively, the wavelength allocation units 41 and 51 of the optical communication network systems 40 and 50 may be achieved by dedicated hardware.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above example embodiments may be described as the following Supplementary Notes, but are not limited to the following.

### Supplementary Note 1

An optical communication network system including:

a wavelength selective switch (WSS) that includes a first input port, a second input port, a first output port, and a second output port, and is capable of selecting an output port for each wavelength component of a signal input from the input port;

a first multiplexing network comprising S₁ (S₁ is an integer of 2 or more) input ports and at least one output port, the first multiplexing network including an optical transmission configuration in which a plurality of couplers are connected in a tree shape, the first multiplexing network being connected to the first input port of the WSS;

a second multiplexing network comprising S₂ (S₂ is an integer of 2 or more) input ports and at least one output port, the second multiplexing network including an optical transmission configuration in which a plurality of couplers are connected in a tree shape, the second multiplexing network being connected to the second input port of the WSS;

a first demultiplexing network comprising at least one input port and T₁ (T₁ is an integer of 2 or more) output ports, the first demultiplexing network including an optical transmission configuration in which a plurality of couplers are connected in a tree shape, the first demultiplexing network being connected to the first output port of the WSS; and

a second demultiplexing network comprising at least one input port and T₂ (T₂ is an integer of 2 or more) output ports, the second demultiplexing network including an optical transmission configuration in which a plurality of couplers are connected in a tree shape, the second demultiplexing network being connected to the second output port of the WSS.

### Supplementary Note 2

The optical communication network system according to supplementary note 1, further including allocation means for allocating a wavelength to each of a plurality of transmission terminals, in which the allocating means

allocates different wavelengths to a first transmission terminal and a second transmission terminal in a case where a first reception terminal that is a communication partner of the first transmission terminal and a second reception terminal that is a communication partner of the second transmission terminal are connected to the same demultiplexing network, and

allocates the same or different wavelengths to the first transmission terminal and the second transmission terminal in a case where the first reception terminal that is the communication partner of the first transmission terminal and the second reception terminal that is the communication partner of the second transmission terminal are connected to different demultiplexing networks.

### Supplementary Note 3

The optical communication network system according to supplementary note 1, in which

an intermediate coupler located between a top and a bottom in the optical transmission configuration of the first multiplexing network is connected to an intermediate coupler of the optical transmission configuration of the first demultiplexing network, and

the top coupler of the optical transmission configuration of the first multiplexing network is connected to the top coupler of the optical transmission configuration of the first demultiplexing network via a wavelength filter.

### Supplementary Note 4

The optical communication network system according to supplementary note 3, further including allocation means for allocating a wavelength to each of a plurality of transmission terminals, in which the allocation means

allocates a wavelength from a first wavelength group to a transmission terminal connected to an input port existing below the intermediate coupler of the first multiplexing network, and

allocates a second wavelength group whose wavelengths do not overlap with wavelengths of the first wavelength group to both of an input port other than an input port subordinate to the intermediate coupler of the first multiplexing network and an output port other than an output port subordinate to the intermediate coupler of the first demultiplexing network.

### Supplementary Note 5

The optical communication network system according to supplementary note 1, in which the first demultiplexing network comprises a wavelength filter between a top coupler and a second-layer coupler in the optical transmission configuration of the first demultiplexing network.

### Supplementary Note 6

An optical communication network system including:

an n×n wavelength selective switch (WSS) that comprises n (n is an integer of 2 or more) input ports and n output ports and is capable of selecting an output port for each wavelength component of a signal input from the input ports;

n multiplexing networks connected to the n input ports of the WSS where an i-th (i is an integer of 1 or more and n or less) multiplexing network comprises Sᵢ input ports and an output port connected to any of the input ports of the WSS; and

n demultiplexing networks connected to the n output ports of the WSS, where a j-th (j is an integer of 1 or more and n or less) demultiplexing network comprises an input port connected to any of the output ports of the WSS, and Tⱼ (j is an integer of 1 or more and n or less) output ports.

What is claimed is:

1. An optical communication network system, comprising:
a wavelength selective switch (WSS) that includes a first input port, a second input port, a first output port, and a second output port, and is capable of selecting an output port for each wavelength component of a signal input from the input port;
a first multiplexing network comprising S₁ (S₁ is an integer of 2 or more) input ports and at least one output port, the first multiplexing network including an optical transmission configuration in which a plurality of couplers are connected in a tree shape, the first multiplexing network being connected to the first input port of the WSS;
a second multiplexing network comprising S₂ (S₂ is an integer of 2 or more) input ports and at least one output port, the second multiplexing network including an optical transmission configuration in which a plurality of couplers are connected in a tree shape, the second multiplexing network being connected to the second input port of the WSS;
a first demultiplexing network comprising at least one input port and T₁ (T₁ is an integer of 2 or more) output ports, the first demultiplexing network including an optical transmission configuration in which a plurality of couplers are connected in a tree shape, the first demultiplexing network being connected to the first output port of the WSS; and
a second demultiplexing network comprising at least one input port and T₂ (T₂ is an integer of 2 or more) output ports, the second demultiplexing network including an optical transmission configuration in which a plurality of couplers are connected in a tree shape, the second demultiplexing network being connected to the second output port of the WSS.

2. The optical communication network system according to claim 1, further comprising:
at least one memory storing instructions, and
at least one processor configured to execute the instructions to;
allocate different wavelengths to a first transmission terminal and a second transmission terminal in a case where a first reception terminal that is a communication partner of the first transmission terminal and a second reception terminal that is a communication partner of the second transmission terminal are connected to the same demultiplexing network; and
allocate the same or different wavelengths to the first transmission terminal and the second transmission terminal in a case where the first reception terminal that is the communication partner of the first transmission terminal and the second reception terminal that is the communication partner of the second transmission terminal are connected to different demultiplexing networks.

3. The optical communication network system according to claim 1, wherein
an intermediate coupler located between a top and a bottom of the optical transmission configuration of the first multiplexing network is connected to an intermediate coupler of the optical transmission configuration of the first demultiplexing network; and
the top coupler of the optical transmission configuration of the first multiplexing network is connected to a top coupler of the optical transmission configuration of the first demultiplexing network via a wavelength filter.

4. The optical communication network system according to claim 3, further comprising:
at least one memory storing instructions, and
at least one processor configured to execute the instructions to;
allocate a wavelength from a first wavelength group to a transmission terminal connected to an input port existing below the intermediate coupler of the first multiplexing network; and
allocate a second wavelength group whose wavelengths do not overlap with wavelengths of the first wavelength group to both of an input port other than an input port subordinate to the intermediate coupler of the first multiplexing network and an output port other than an output port subordinate to the intermediate coupler of the first demultiplexing network.

5. The optical communication network system according to claim 1, wherein the first demultiplexing network comprises a wavelength filter between a top coupler and a second-layer coupler in the optical transmission configuration of the first demultiplexing network.
